(19) United States
(12) Patent Application Publication
(10) Pub. No.: US 2025/0216203 A1
(43) Pub. Date: Jul. 3, 2025

(54) METHOD AND APPARATUS FOR VISUAL INERTIAL ODOMETRY TO IMPLEMENTING VISUAL SLAM IN REALTIME

(71) Applicant: TSP XR, Nowon-gu (KR)

(72) Inventors: Chan Soo PARK, Gangbuk-gu (KR); Chi Seo JEONG, Nowon-gu (KR); In Seon KIM, Dongjak-gu (KR); Hoi Jun KIM, Dobong-gu (KR); Jin Kyu KANG, Yongsan-gu (KR)

(21) Appl. No.: 18/959,926

(22) Filed: Nov. 26, 2024

(30) Foreign Application Priority Data
Dec. 27, 2023 (KR) 10-2023-0192243
Feb. 19, 2024 (KR) 10-2024-0023218

(51) Int. Cl. G01C 21/16; G06T 7/73; G06V 10/44; G06V 10/80; G06V 10/84

(52) U.S. Cl. CPC G01C 21/1656; G06T 7/73; G06V 10/454; G06V 10/806; G06V 10/84

(57) ABSTRACT

The present disclosure provides a method of visual inertial odometry performed in an apparatus for visual inertial odometry, including (a) acquiring image data from a camera sensor and acquiring inertial data from an inertial measurement unit, (b) performing a convolution operation on the image data to extract image feature information and performing the convolution operation on the inertial data to extract inertial feature information, (c) determining whether to use the image feature information, and (d) estimating a camera pose based on the used image feature information and the inertial feature information determined to be used according to a result of determining whether to use the image feature information.

### CROSS-REFERENCE TO RELATED APPLICATIONS

This application claims the priority of Korean Patent Application No. 2023-0192243 filed on Dec. 27, 2023, in the Korean Intellectual Property Office, and Korean Patent Application No. 2024-0023218 filed on Feb. 19, 2024, in the Korean Intellectual Property Office, the disclosures of which are incorporated herein by reference.

### BACKGROUND

### Field

The present disclosure relates to a visual inertial odometry (VIO) technology, and more particularly, to a method and apparatus for visual inertial odometry capable of minimizing an image operation process to implement visual-simultaneous localization and mapping (visual-SLAM) in real time on a mobile device.

### Description of the Related Art

A visual inertial odometry (VIO) technology is an element technology that estimates a position of an observer for creating a global spatial map of simultaneous localization and mapping (SLAM), and is a technology necessary for augmented reality (AR) or autonomous driving which is fields requiring three-dimensional spatial recognition. The VIO technology is divided into feature-based VIO and deep learning-based VIO according to an approach. The deep learning-based approach preprocesses data acquired from a camera sensor and an inertial measurement unit (IMU) and then estimates a camera pose through forward propagation. Most deep learning-based VIO methods estimate the camera pose in this way.

Recently, the deep learning-based VIO methods have been developed through various studies to improve the accuracy of camera pose estimation. As a result, traditional feature-based methods are gradually being replaced by deep learning models.

However, the deep learning models have complex computational processes, so computational acceleration technologies such as GPU are required for real-time processing. In particular, a weight reduction of the model is essential for application to mobile devices or web environments. However, when there is no optimization process from the model design stage, an inference time becomes long, making it difficult to integrate additional technologies such as the augmented reality or SLAM.

### RELATED ART DOCUMENT

### Patent Document

(Patent Document 1) Korean Patent Laid-Open Publication No. 10-2023-0097690

### SUMMARY

An object to be achieved by the present disclosure is to provide a method and apparatus for visual inertial odometry to implement visual SLAM in real time on a mobile device.

Another object to be achieved by the present disclosure is to provide a method and apparatus for visual inertial odometry capable of saving computational costs by selectively omitting an image processing process in consideration of computational performance of a mobile device.

Still another object to be achieved by the present disclosure is to provide a method and apparatus for visual inertial odometry capable of calculating six degrees of freedom of a camera required to implement SLAM by estimating the amount of change in movement and rotation of continuous camera viewpoints.

The objects of the present disclosure are not limited to the above-mentioned objects. That is, other objects that are not mentioned may be obviously understood by those skilled in the art from the following description.

A method of visual inertial odometry performed in an apparatus for visual inertial odometry according to an exemplary embodiment of the present disclosure includes (a) acquiring image data from a camera sensor and acquiring inertial data from an inertial measurement unit, (b) performing a convolution operation on the image data to extract image feature information and performing the convolution operation on the inertial data to extract inertial feature information, (c) determining whether to use the image feature information, and (d) estimating a camera pose based on the used image feature information and the inertial feature information determined to be used according to a result of determining whether to use the image feature information.

The (b) may include performing a two-dimensional convolution operation on the image data acquired from the camera sensor, and extracting image feature information corresponding to a texture, an edge, or a color pattern through the two-dimensional convolution operation.

The method may further include, prior to the (b), training to estimate an optical flow for extracting the image feature information.

The (b) may include calculating an amount of change in the image data, and updating a weight to minimize a calculation error for the camera pose depending on the amount of change.

The (b) may include performing a one-dimensional convolution operation on the inertial data acquired from the inertial measurement unit, and extracting the inertial feature information corresponding to the pattern or change over time through the one-dimensional convolution operation.

The (c) may include calculating an output value corresponding to a specific element through [Equation 1] below based on the inertial feature information and an output result at a previous time of a long short-term memory.

$${c}_{t} = [ {h}_{t - 1} ; {e}_{t} ] \\ {select}_{t} ( x ) = {\sum }_{i = - a}^{a} {c}_{t} ( x + i ) \cdot K ( i ) \qquad [ Equation 1 ]$$

Here, cₜ denotes an input value, hₜ₋₁ denotes the output result at the previous time of the long short-term memory, et denotes the inertial feature information, and selecₜ(x) denotes an output value corresponding to a specific element x of cₜ.

The (c) may include applying Gumbel-softmax to the output value to calculate a probability value, and multiplying the probability value by the output value to change the output value to 0 or 1.

The calculating of the probability value may include generating Gumbel noise to apply the Gumbel-softmax to the output value, adding the Gumbel noise to the output value, and applying a softmax function that adjusts continuity of an output distribution through a temperature parameter to the output value to which the Gumbel noise is added.

The calculating of the probability value may include generating the Gumbel noise as in [Equation 2] below,

$$G = - log ( - log ( V ) ) \qquad [ Equation 2 ]$$

adding the Gumbel noise to the output value as in [Equation 3] below, and

$${logits}_{gumble} = logits + G \qquad [ Equation 3 ]$$

applying the softmax function as in [Equation 4] below based on the output value to which the Gumbel noise is added.

$${g}_{i} = \frac{exp ( {( {logits}_{gumbel} )}_{i} / τ )}{{\sum }_{j = 1}^{K} exp ( {( {logits}_{gumbel} )}_{j} / τ )} \qquad [ Equation 4 ]$$

Here, G denotes the Gumbel noise, U denotes a random number sampled from a uniform distribution between 0 and 1, logits denotes the output value, (logits_{gumbel})ᵢ denotes the output value to which the Gumbel noise is added for an i-th class, K denotes the number of classes to be classified, and τ denotes the temperature parameter.

The (d) may include forming a tensor by connecting the used image feature information and inertial feature information along a dimension axis, acquiring an output result at a current time of the long short-term memory based on the output result at the previous time of the tensor and the long short-term memory, and representing the output result at the current time as a vector for each axis through a fully connected layer.

A loss function may be defined as a sum of a loss function for determining whether to use the image feature information and a loss function for estimating the camera pose.

The loss function for determining whether to use the image feature information may be as in [Equation 5] below where a penalty term is applied as a temperature parameter of Gumbel-softmax.

$${Loss}_{selection} = \frac{1}{seq - 1} {\sum }_{t = 1}^{seq - 1} λ {g}_{t} \qquad [ Equation 5 ]$$

Here, seq denotes a length of a sequence, λ denotes the penalty term, and gₜ denotes a result value of applying the Gumbel-softmax to an output value.

The loss function for estimating the camera pose may correspond to a square loss of a Euclidean norm of a translation vector and a rotation vector representing the camera pose as in [Equation 6] below.

$${Loss}_{pose} = \frac{1}{seq - 1} {\sum }_{t = 1}^{seq - 1} ( {‖ \vec{{v}_{t}^{′}} - \vec{{v}_{t}} ‖}_{2}^{2} + α \times {‖ \vec{{r}_{t}^{′}} - \vec{{r}_{t}} ‖}_{2}^{2} ) \qquad [ Equation 6 ]$$

Here, seq denotes a length of a sequence, α=100, \vec{v} denotes the translation vector, and \vec{r} denotes the rotation vector.

An apparatus for visual inertial odometry according to another exemplary embodiment of the present disclosure includes a data acquisition unit that acquires image data from a camera sensor and acquires inertial data from an inertial measurement unit, an image encoder that performs a convolution operation on the image data to extract image feature information, an IMU encoder that performs the convolution operation on the inertial data to extract inertial feature information, a visual determination unit that determines whether to use the image feature information, and a pose estimation unit that estimates a camera pose based on the used image feature information and the inertial feature information determined to be used according to a result of determining whether to use the image feature information.

The visual determination unit may calculate an output value corresponding to a specific element based on the inertial feature information and an output result at a previous time of a long short-term memory.

The visual determination unit may apply Gumbel-softmax to the output value to derive a probability value, and multiply the probability value by the output value to change the output value to 0 or 1.

The visual determination unit may generate Gumbel noise to apply the Gumbel-softmax to the output value, add the Gumbel noise to the output value, and apply a softmax function that adjusts continuity of an output distribution through a temperature parameter to the output value to which the Gumbel noise is added.

The apparatus may further include a learning unit that trains to estimate an optical flow for extracting the image feature information, and updates a weight to minimize a calculation error for the camera pose depending on an amount of change in the image data.

According to a third aspect of the present disclosure, there is provided a computer program stored in a computer-readable medium, in which when a command of the computer program is executed, the method of visual inertial odometry is performed.

As described above, according to the present disclosure, by minimizing the image operation process, it is possible to implement the real-time location estimation, and by securing the real-time and precision, it is possible to expand to fields requiring location estimation, such as augmented reality (AR), SLAM (SLAM), or autonomous driving.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of an apparatus for visual inertial odometry according to a preferred embodiment of the present disclosure;

FIG. 2 is a flowchart of a method of visual inertial odometry according to an embodiment;

FIG. 3 is an exemplary diagram for describing the method of visual inertial odometry according to an embodiment;

FIG. 4 is an exemplary diagram for describing an image encoder according to an embodiment;

FIG. 5 is an exemplary diagram for describing a Gumbel-softmax output result according to an embodiment;

FIG. 6 is a diagram for describing a change in loss according to the training number iteration according to an embodiment;

FIG. 7 is a diagram for describing a camera pose trajectory calculation result depending on the training number iteration according to an embodiment; and

FIG. 8 is an exemplary diagram for describing a global pose calculation result according to an embodiment.

### DETAILED DESCRIPTION OF THE EMBODIMENT

Hereinafter, advantages and features of the present disclosure and methods for accomplishing these advantages and features will become apparent from embodiments to be described later in detail with reference to the accompanying drawings. However, the present disclosure is not limited to embodiments disclosed below, and may be implemented in various different forms, these embodiments will be provided only in order to make the present disclosure complete and allow one of ordinary skill in the art to which the present disclosure pertains to completely recognize the scope of the present disclosure, and the present disclosure will be defined by the scope of the claims. Throughout the specification, the same components will be denoted by the same reference numerals. “And/or” includes each and every combination of one or more of the mentioned items.

The terms ‘first’, ‘second’, and the like are used to describe various elements, components, and/or sections, but these elements, components, and/or sections are not limited by these terms. These terms are used only in order to distinguish one element, component, or section from another element, component or section. Accordingly, a first element, a first component, or a first section to be mentioned below may also be a second element, a second component, or a second section within the technical spirit of the present disclosure.

In addition, in each step, an identification code (for example, a, b, c, and the like) is used for convenience of description, and the identification code does not describe the order of each step, and each step may be different from the specified order unless the context clearly indicates a particular order. That is, the respective steps may be performed in the same order as the specified order, be performed at substantially the same time, or be performed in an opposite order to the specified order.

As used herein, the terms are for describing embodiments rather than limiting the present disclosure. Unless explicitly described to the contrary, a singular form includes a plural form in the present specification. The word “comprises” and/or “comprising” used in the present specification will be understood to imply the inclusion of stated component, steps, operations and/or elements but not the exclusion of any other components, steps, operations and/or elements.

Unless defined otherwise, all the terms (including technical and scientific terms) used herein have the same meaning as meanings commonly understood by one of ordinary skill in the art to which the present disclosure pertains. In addition, the terms defined in generally used dictionaries are not ideally or excessively interpreted unless they are specifically defined clearly.

In addition, in describing embodiments of the present disclosure, when it is decided that a detailed description for well-known functions or configurations may unnecessarily obscure the gist of the present disclosure, the detailed description will be omitted. In addition, the following terms are terms defined in consideration of the functions in embodiments of the present disclosure, and may be construed in different ways by the intention of users and operators, customs, or the like. Therefore, the definitions thereof should be construed based on the contents throughout the specification.

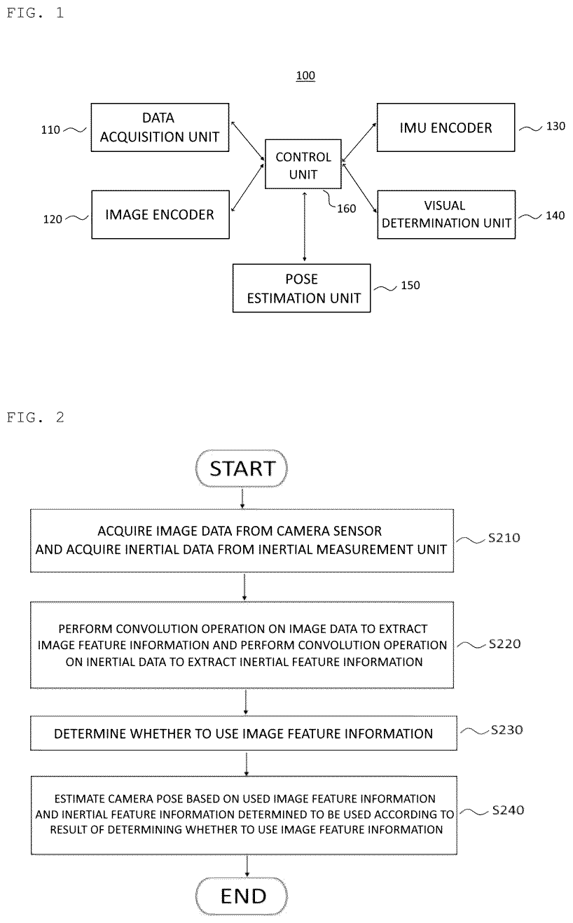

FIG. 1 is a block diagram of an apparatus for visual inertial odometry according to a preferred embodiment of the present disclosure.

The apparatus 100 for visual inertial odometry is an apparatus for performing a method of visual inertial odometry according to the present disclosure. Visual inertial odometry (VIO) is a technology for estimating six degrees of freedom (6DoF) of an observer's camera using image data and inertial data which is a data value of an inertial measurement unit (IMU) sensor as an inertial measurement unit. Here, three of the six degrees of freedom are positions, and the remaining three degrees of freedom are orientations. By using the position and orientation values, it is possible to know the capturing position of a camera viewpoint in a three-dimensional space. Preferably, the apparatus 100 for visual inertial odometry estimates changes in position and orientation by analyzing a difference between a previous view frame and a current view frame, and the camera position estimated by using the image data and the inertial data together in the apparatus 100 for visual inertial odometry may be used to implement visual-simultaneous localization and mapping (visual-SLAM). Here, the SLAM is a technology that estimates a position of a node (e.g., a robot or a camera, etc.) and creates a global map in real time using data acquired from a camera or sensor, and the visual-SLAM means the SLAM that estimates the position using camera data. In order to implement the visual-SLAM, the position estimation of the node should be performed precisely.

Preferably, the apparatus 100 for visual inertial odometry may be a computer, and may install and execute an application or program for performing a method of visual inertial odometry, and include a user interface so that the input and output of data may be controlled. Here, the computer means all kinds of hardware devices including at least one processor, and may be understood as including a software configuration which is operated in the corresponding hardware device according to the embodiment. For example, the computer may be understood as a meaning including all of smart phones, tablet PCs, desktops, laptops, and user clients and applications running on each device, but is not limited thereto.

Referring to FIG. 1, the apparatus 100 for visual inertial odometry includes a data acquisition unit 110, an image encoder 120, an IMU encoder 130, a visual determination unit 140, a pose estimation unit 150, and a control unit 160. Here, the control unit 160 controls the operations of the data acquisition unit 110, the image encoder 120, the IMU encoder 130, the visual determination unit 140, and the pose estimation unit 150, and the flow of data.

The data acquisition unit 110 acquires and stores data from the camera sensor and the inertial measurement unit (IMU). Preferably, the image data is acquired from the camera sensor, and the inertial data, which is the IMU sensor data, is acquired from the inertial measurement unit.

The image encoder 120 extracts image feature information from the image data acquired from the camera sensor. Preferably, the image encoder 120 may extract feature points by calculating points with high gradients in an image and match feature points at a previous time with feature points at a next time. Conventionally, rule-based computer vision algorithms such as scale-invariant feature transform (SIFT), speeded up robust features (SURF), or oriented FAST and rotated BRIEF (ORB) have been used to extract the feature information, but the feature extraction performance of these methods has a problem in that deviation may occur depending on parameter setting values of the algorithm, so the image encoder 120 extracts the image feature information through deep learning operations.

The IMU encoder 130 extracts the inertial feature information from inertial data acquired from the inertial measurement unit. That is, the IMU encoder 130 acquires feature information to analyze consecutive inertial data.

Preferably, the image encoder 120 and the IMU encoder 130 may extract feature information necessary for pose estimation through a convolution operation of image data and inertial data based on deep learning, respectively. The feature information may analyze visual changes in sensor data to interpret important information for activity recognition, orientation estimation, or mapping operations.

The visual determination unit 140 determines whether to use the image feature information extracted from the image encoder 120. Since the computational complexity of the image data is much greater than that of the inertial data, the visual determination unit 140 determines whether to use the image feature information so that the image operation process may be selectively omitted for real-time camera pose estimation. In terms of the computational complexity of the image data and the inertial data, for example, to compare the convolution operation costs of the image data and the inertial data, it is assumed that the number of filters is 32 and a kernel size is 3×3. For the image, when it includes an operation of horizontal and vertical channels of a kernel (3×3×3) at a resolution of 512×512×3, the computational costs of the image data are 512×512×3×3×3×32=226,492,416. On the other hand, for the inertial data, when the kernel size is 3, the number of filters is 128, the number of data dimensions is 6, and a sequence length is N, the computational costs are N×3×6×128=N×2,304. Since the inertial data sampled between two points in time does not exceed a maximum frequency value of a sensor, when the sensor value of the inertial measurement unit has a maximum frequency of 100 Hz, the computational costs are at most 230,400. That is, it may be seen that the computational complexity of the image data is much greater than that of the inertial data.

The pose estimation unit 150 estimates a camera pose based on the used image feature information and inertial feature information determined to be used through the visual determination unit 140. Preferably, the pose estimation unit 150 may estimate a translation vector and a rotation vector, calculate an orientation transformation, and calculate a camera pose trajectory. This is to predict how much the camera has moved based on the previous view frame. More specifically, the translation vector is an estimate of how much the camera has moved from the previous view frame through a deep learning algorithm, and is based on a position of a previous view camera frame, and the rotation vector is an estimate of how much the camera has moved from the previous view frame through the deep learning algorithm, similar to the translation vector, and the rotation vector may be easily transformed into a 3×3 rotation matrix using an Euler angle as in Equation 3. The orientation transformation is used to model the change in camera orientation in a three-dimensional space, and may be expressed as a rotation value R and a translation value t as in Equation 1 below.

$${p}_{i}^{′} \approx {RP}_{i} + t \qquad [ Equation 1 ]$$

Here, P denotes a 3D space coordinate (position of an object) at a previous time, p′ denotes a transformed 3D space coordinate, R denotes a 3×3 matrix indicating the rotation, and a rotation matrix of each axis (x, y, z) in the 3D space is calculated by a matrix multiplication as in [Equation 2] below.

$${R}_{x} ( ϕ ) = ( \begin{matrix}1 & 0 & 0 \\ 0 & cos ( ϕ ) & - sin ( ϕ ) \\ 0 & sin ( ϕ ) & cos ( ϕ )\end{matrix} ) \\ {R}_{y} ( θ ) = ( \begin{matrix}cos ( θ ) & 0 & sin ( θ ) \\ 0 & 1 & 0 \\ - sin ( θ ) & 0 & cos ( θ )\end{matrix} ) \\ {R}_{z} ( ψ ) = ( \begin{matrix}cos ( ψ ) & - sin ( ψ ) & 0 \\ sin ( ψ ) & cos ( ψ ) & 0 \\ 0 & 0 & 1\end{matrix} ) \\ R = {R}_{z} ( ψ ) {R}_{y} ( θ ) {R}_{x} ( ϕ ) \qquad [ Equation 2 ]$$

In addition, t means the translation vector for each axis (x, y, z) as in [Equation 3] below.

$$t = [ \begin{matrix}{t}_{x} \\ {t}_{y} \\ {t}_{z}\end{matrix} ] \qquad [ Equation 3 ]$$

Preferably, the pose estimation unit 150 may estimate the amount of change in the camera pose of two consecutive frames by repeating the process of acquiring data, extracting and matching the feature information, estimating the translation vector, and calculating the orientation transformation. Accordingly, an estimation operation required for the SLAM may be performed using the calculated camera trajectory, and the operation means a mapping operation of configuring information on the surrounding environment through self-localization in a global space (3D space).

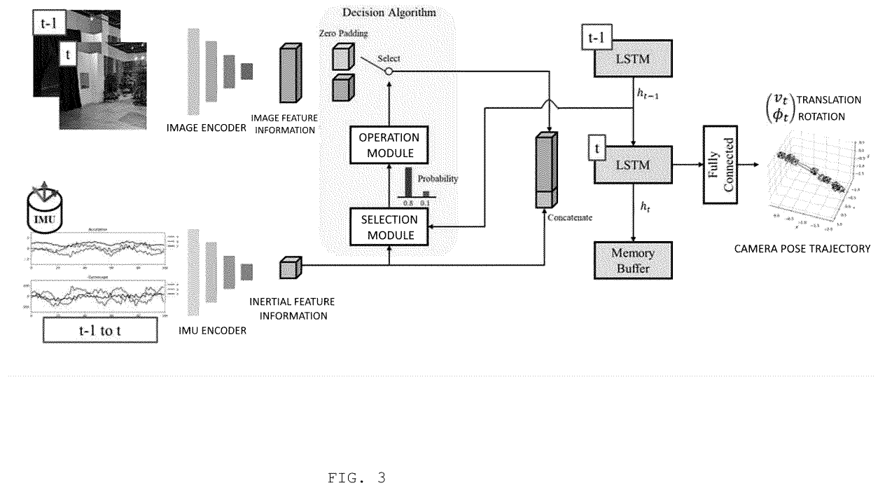

The operations performed through each configuration of the apparatus 100 for visual inertial odometry illustrated in FIG. 1 will be described in detail with reference to FIG. 2 below. Each step to be described with reference to FIG. 2 is described as being performed by different configurations, but is not limited thereto, and at least some of each step may also be performed in the same or different configurations according to the embodiment.

FIG. 2 is a flowchart of a method of visual inertial odometry according to an embodiment.

Referring to FIG. 2, the data acquisition unit 110 acquires the image data from the camera sensor and acquires the inertial data from the inertial measurement unit (step S210).

The image encoder 120 performs the convolution operation on the image data to extract the image feature information, and the IMU encoder 130 performs the convolution operation on the inertial data to extract the inertial feature information (step S220).

Preferably, the image encoder 120 performs a two-dimensional convolution operation on the image data acquired from the camera sensor and extracts the image feature information corresponding to visual information such as texture, an edge, or a color pattern through the two-dimensional convolution operation. In the case of the image, since both spatial dimensions (horizontal and vertical) and depth (channel) should be considered, many computational costs are required, and the amount of computation may increase rapidly as the image resolution increases. More specifically, the two-dimensional convolution operation process for the image data is as in [Equation 4] below, and the two-dimensional convolution operation is a process of moving a convolution kernel K over an image I, element-wise multiplying the kernel by the corresponding part of the image, and then adding the results.

$$C ( x , y ) = {\sum }_{i = - 1}^{1} {\sum }_{j = - 1}^{1} I ( x + i , y + j ) \cdot K ( i , j ) \qquad [ Equation 4 ]$$

Here, K(i, j) denotes a specific element of the convolution kernel, and I(x+i, y+i) denotes an element of the same position in the image.

In an embodiment, the apparatus 100 for visual inertial odometry may include a learning unit (not illustrated in the drawing), and the learning unit may train to estimate an optical flow for extracting the image feature information, calculate the amount of change in the image data, and update weights of the deep learning algorithm to minimize the calculation error for the camera pose depending on the amount of change. Here, the amount of change in the image data means the amount of change for each pixel of consecutive frames (e.g., t, t+1, t+2, . . . ). For example, since a still image has only a degree of change due to brightness or air flow, there is not almost the amount of change in image data, and when the camera moves, a difference in image pixel values may occur, which is called the amount of change. Preferably, the learning unit pre-trains a deep learning model in an optical flow estimation task to improve the feature information extraction capability of the image encoder 120. Here, the optical flow is a method of analyzing an image movement pattern generated by the movement of an object or a camera in an image sequence (video), and may estimate an actual 3D movement amount by tracking the movement within a visual scene. Referring to FIG. 4, a deep learning model of an encoder-decoder structure for estimating the optical flow is provided, in which the encoder may extract important feature information from consecutive images and trains features and patterns of a moving object, and the decoder may represent the movement of each pixel as a three-dimensional vector field based on the feature information extracted from the encoder. The learning unit performs pre-training by separating only the encoder structure from the encoder-decoder trained to estimate the optical flow, and the pre-trained encoder may be used as the image encoder 120 to calculate the amount of change in the image, and may newly update the weights of the deep learning model in a direction that optimizes the calculation error of the camera pose depending on the amount of change.

The IMU encoder 130 performs a one-dimensional convolution operation on inertial data acquired from the inertial measurement unit, and extracts the inertial feature information corresponding to the pattern or change over time through the one-dimensional convolution operation. In the case of the inertial data, since only the temporal dimension is considered, the computational costs are relatively low, the data length is short, the dimension is low, and the computation is simple. Preferably, the IMU encoder 130 performs the 1-dimensional convolution operation on the inertial data as in [Equation 5] below. Here, the 1-dimensional convolution is applied to time series data or a 1-dimensional signal, and the computation is performed assuming that the inertial data sequence is a 1-dimensional signal. A convolution result C(x) at a specific location x is calculated as in [Equation 5] below, and the convolution result value corresponds to the inertial feature information.

$$C ( x ) = {\sum }_{i = - 1}^{1} D ( x + i ) \cdot K ( i ) \qquad [ Equation 5 ]$$

Here, D(x+i) denotes the corresponding position value of the inertial data sequence, and K(i) denotes an element of the convolution kernel.

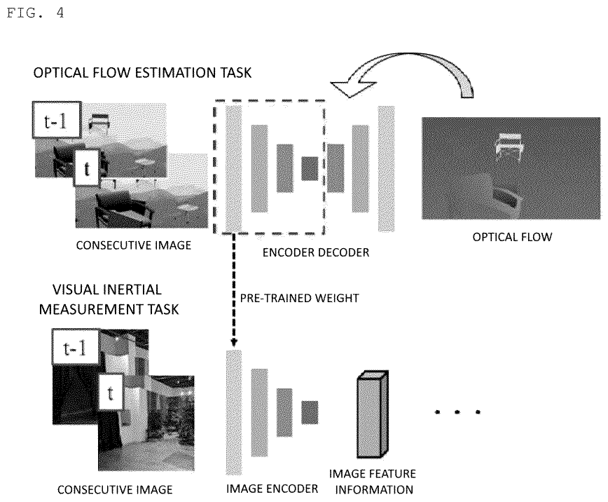

The visual determination unit 140 determines whether to use the image feature information extracted from the image encoder 120 (step S230). Preferably, the visual determination unit 140 may be composed of a selection module and an operation module with reference to FIG. 3. The selection module may calculate an output value corresponding to a specific element through [Formula 6] below based on the inertial feature information and an output result at a previous time of a long short-term memory (LSTM). Here, the specific element means the feature information required for the visual determination, and since the shape of the input data of the selection module is a multidimensional array, the specific element may be used to create a result identical to the size of the input data. For example, when input data (100, 100) is a 100×100 array, the output should also be (100, 100), so the specific element is used.

$${c}_{t} = [ {h}_{t - 1} ; {e}_{t} ] \\ {select}_{t} ( x ) = {\sum }_{i = - a}^{a} {c}_{t} ( x + i ) \cdot K ( i ) \qquad [ Equation 6 ]$$

Here, cₜ denotes an input value of the selection module, hₜ₋₁ denotes the output result at the previous time of the long short-term memory, et denotes the inertial feature information, and selecₜ(x) denotes the output value corresponding to the specific element x of cₜ through the one-dimensional convolution as a result of the operation of the selection module.

The output acquired through the selection module means a raw value output from a final layer of the deep learning module and is an output of a linear layer that has not undergone an activation function or normalization process. The output is called logits and may not be expressed as a discrete probability distribution because it indicates the reliability of the deep learning model. However, the neural network may be trained by parameterizing the discrete probability distribution and may be handled like an actual discrete probability distribution through Gumbel-softmax. In order to determine whether to use the image feature information, the output of the visual determination unit 140 should be [0, 1]. However, it is not possible to make an output binary based on a simple threshold or use a software function such as arguments of the maxima (Argmax). The training through backpropagation in the neural network requires a differentiable function, but the Argmax returns an index of an element with the highest value in a probability vector. In addition, even if the discrete selection process is directly modeled, the gradient is 0 or diverges. This makes it impossible to train the deep learning model because the weights of the neural network may not be updated. Therefore, the Gumbel-softmax operation is taken to make the deep learning model binary-selectable and differentiable.

Preferably, the operation module may apply the Gumbel-softmax to the output value acquired through the selection module to calculate the probability value, and change the output value to 0 or 1 by multiplying the probability value by the output value. Here, the Gumbel-softmax operation is a method of converting a discrete probability distribution into a continuous approximation, which enables the deep learning model to perform the gradient-based learning. More specifically, the operation module generates Gumbel noise as in [Equation 7] below to apply the Gumbel-softmax to the output value, and the Gumbel noise is sampled from the Gumbel distribution. Next, the operation module may add the Gumbel noise to the output value (logits) as in [Equation 8] below to allow the discrete selection to be continuously approximated, and applies the Gumbel-softmax, which adjusts the continuity of the output distribution through the temperature parameter, to the output value to which the Gumbel noise is added as in [Equation 9] below to make the output value to which noise is added into a probability distribution, thereby calculating the probability value. In the softmax function, exp denotes an exponential function, and the denominator of the equation represents the sum of exponential functions for all classes, which serves to normalize the probability distribution so that the total sum becomes 1.

$$G = - log ( - log ( U ) ) \qquad [ Equation 7 ]$$

$${logits}_{gumbel} = logits + G \qquad [ Equation 8 ]$$

$${g}_{i} = \frac{exp ( {( {logits}_{gumbel} )}_{i} / τ )}{{\sum }_{j = 1}^{K} exp ( {( {logits}_{gumbel} )}_{j} / τ )} \qquad [ Equation 9 ]$$

Here, G denotes the Gumbel noise, U denotes a random number (i.e., U to Uniform (0, 1)) sampled from a uniform distribution between 0 and 1, logits denotes the output value, (logits_{gumbel})ᵢ denotes the output value to which the Gumbel noise is added for an i-th class, K denotes the number (i.e., since it is binary classification, K=2) of classes to be classified, and τ denotes the temperature parameter.

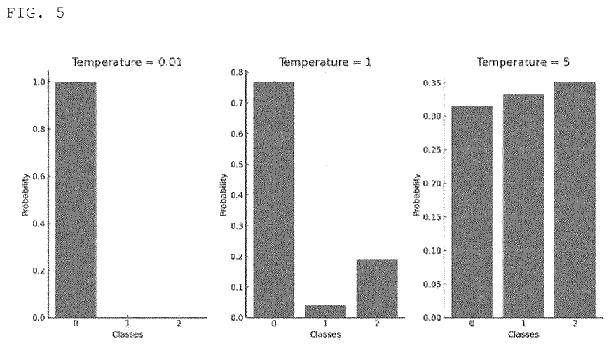

Here, the closer the temperature parameter is to 0, the more discrete the output result becomes, and the higher the temperature parameter is, the more continuous the output becomes. When the output value of the logit is [1.5, 1.0, 0.2], the softmax function may convert the output value into a probability and calculate the output value with the probability that each class represents the given input. In this case, the sum of the output results should be 1, and FIG. 5 illustrates the result of applying the Gumbel-Softmax to the logit output value. Referring to FIG. 5, when the temperature parameter is 0.01, 1, and 5 in order from the left graph, it shows the probability of each class, and when the temperature is very low, the output of the operation module assigns a very high probability to one class and the values of the other classes are ignored. This means that discrete output is possible. It may be seen that the output when the temperature is 1 shows a smooth probability distribution, and the probability for each class is distinct but evenly distributed. Finally, when the temperature is high, it may be seen that almost equal probabilities are assigned to all classes, which means very continuous output, and the difference in probabilities of each class becomes small.

Preferably, the operation module may perform a multiplication operation on the probability value calculated through the Gumbel-softmax by the output (i.e., the convolution result value) of the image encoder 120 to select whether to fill the output value of the image encoder 120 with 0. When performing the matrix multiplication in the deep learning, a tensor filled with 0 always becomes 0 when multiplied by another tensor, so the result may be set to 0 without actually performing the matrix multiplication operation. In other words, when the output value of the image encoder 120 is filled with 0, the output result of the image encoder 120, which requires a lot of computational costs, may be omitted, which may greatly reduce the computational costs.

The pose estimation unit 150 estimates the camera pose based on the used image feature information and the inertial feature information determined to be used according to a result of determining whether to use the image feature information (step S240). Here, the used image feature information corresponds to the image feature information whose output value of the image encoder 120 is filled with 1 through the visual determination unit 140.

Preferably, the pose estimation unit 150 may form a tensor by connecting the used image feature information and inertial feature information along a dimension axis, acquire the output result at the current time of the long short-term memory based on the output result at the previous time of the tensor and the long short-term memory, and represent the output result at the current time as a vector for each axis through the fully connected layer More specifically, referring to FIG. 3, the pose estimation unit 150 concatenates the used image feature information and inertial feature information as the last dimension axis, and here, the tensor connected as the dimension axis may train the long short-term dependencies in time series data through the long short-term memory (LSTM) layer. A general deep learning model outputs results according to input data, but the long short-term memory applied to the present disclosure performs predictions on new data by reflecting the previous output results, and this process through the long short-term memory is called the long short-term dependency. In addition, the deep learning model improves the pose estimation performance by identifying patterns over time in continuous images or inertial data. In other words, since, like the image data, the inertial data is given continuous changes, when the long short-term memory is used, the prediction ability may be improved and how the inertial data values change over time may be reflected. This process is calculated using the output result at the previous time hₜ₋₁ of the long short-term memory and the output result of the selection module, and an output result hₜ at the current time is stored in a computer memory (memory buffer) for a calculation at a next time hₜ₊₁.

Preferably, the pose estimation unit 150 may express the output result hₜ of the long short-term memory as a vector for each axis as in [Equation 10] below through a fully connected layer. Here, the output result of the fully connected layer is “(sequence length, 6)”, the sequence length is an image viewpoint (t, t+1, . . . , t+n), and 6 means 3 rotation vectors and 3 translation vectors.

$$\vec{v} = [ \begin{matrix}{v}_{x} \\ {v}_{y} \\ {v}_{z}\end{matrix} ] \qquad [ Equation 10 ]$$

Here, \vec{v} denotes a translation vector and \vec{r} denotes a rotation vector. That is, the final value output through the pose estimation unit 150 is a translation vector and a rotation vector representing the camera pose.

In an embodiment, the binary determination process through the visual determination unit 140 is differentiable through the Gumbel-softmax, so weight training through a loss function is possible. The loss function of the method of visual inertial odometry may be defined as the sum of the loss function (hereinafter, referred to as the ‘selection module loss function’) for determining whether to use the image feature information and the loss function (hereinafter, referred to as the ‘pose loss function’) for estimating the camera pose, as in [Equation 11] below.

$$Loss = {Loss}_{pose} + {Loss}_{selection} \qquad [ Equation 11 ]$$

Here, Lossₚₒₛₑ denotes the pose loss function, and Loss_{selection} denotes the selection module loss function.

Specifically, for the selection module loss function, the penalty term is applied as the temperature parameter of Gumbel-softmax as in [Equation 12] below, and the pose loss function may correspond to a square loss of a Euclidean norm L2 of the translation vector and rotation vector representing the pose of the camera as in [Equation 13] below.

$${Loss}_{selection} = \frac{1}{seq - 1} {\sum }_{i = 1}^{seq - 1} λ {g}_{t} \qquad [ Equation 12 ]$$

Here, seq denotes a length of a sequence, λ denotes the penalty term, and gₜ denotes a result value of applying the Gumbel-softmax to an output value.

$${Loss}_{pose} = \frac{1}{seq - 1} {\sum }_{t = 1}^{seq - 1} ( {‖ \vec{{v}_{t}^{′}} - \vec{{v}_{t}} ‖}_{2}^{2} + α \times {‖ \vec{{r}_{t}^{′}} - \vec{{r}_{t}} ‖}_{2}^{2} ) \qquad [ Equation 13 ]$$

Here, seq denotes a length of a sequence, α=100, \vec{v} denotes the translation vector, and \vec{r} denotes the rotation vector.

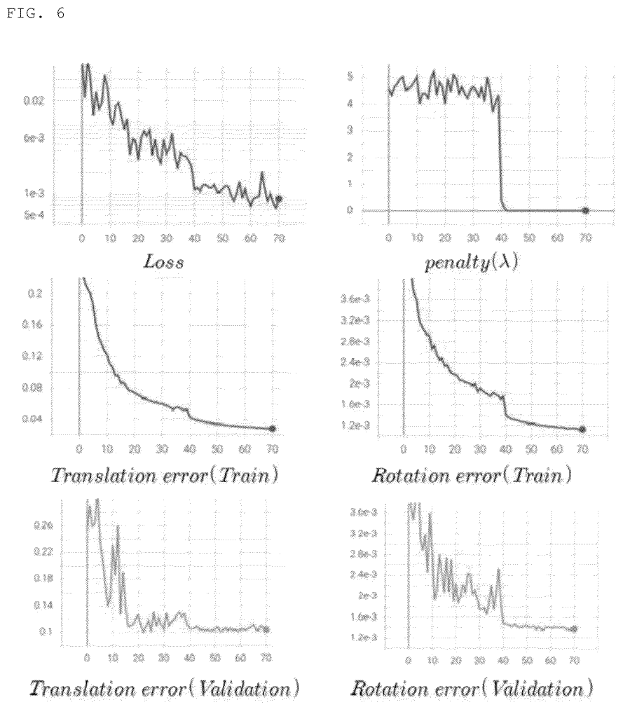

FIG. 6 is a diagram describing a change in loss according to the training number iteration according to an embodiment.

Referring to FIG. 6, the graph shows the change in the loss value according to the training number (epoch) iteration. An x-axis of each graph represents the training number, and the selection module increases the frequency of output inactivation of the image encoder 120 by gradually reducing the penalty value. Here, the output inactivation sets all the values of the image feature information to 0. When set to 0, the output value is 0 when the multiplication operation is performed, so the operation process may be omitted, thereby increasing the inference speed. When the frequency of inactivation increases, the operation on the image feature information may be omitted, which may help reduce weight. It may be seen that both the translation error (validation)) and the rotation error (validation) are reduced without overfitting to the training data (translation error (train) and rotation error (train)), and it may be seen that both the translation error and the rotation error are greatly reduced at the point where the penalty term becomes 0 (epoch=40). This means that the pose estimation is possible even without using the image encoder 120.

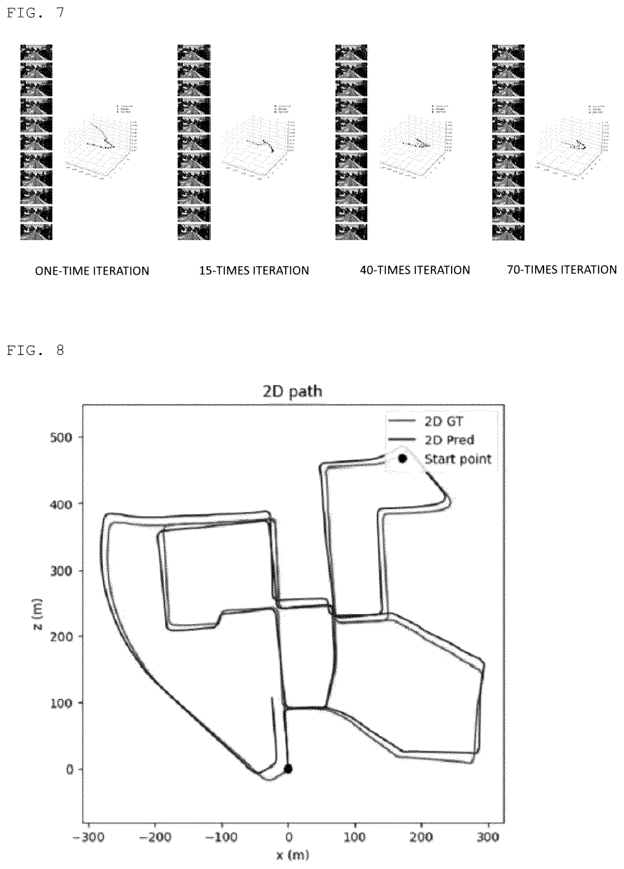

FIG. 7 is a diagram for describing a result of calculating the camera pose trajectory according to the training number iteration according to an embodiment, and FIG. 8 is an exemplary diagram for describing a result of calculating the global pose according to an embodiment.

Referring to FIG. 7, the result of calculating the pose trajectory according to the training number iteration of the training sequence data shows the difference value between the correct answer and the predicted result. It may be seen that the trajectory of the error (red graph) for the training data during the training process in the three-dimensional space approaches the error (blue graph) for the verification data (i.e., the test data), and this trajectory is the change amount (relative pose) for each frame between the sequence data, and may be expressed as a global pose through this. When all the sequence data are combined, the global pose may be calculated as in FIG. 8. Referring to FIG. 8, 2D GT is the global pose of the correct answer data and 2D Pred is the global pose of predicted data, which shows that the global pose similar to the correct answer data may be estimated while significantly reducing the usage proportion of the image encoder 120 through the selection module. Accordingly, when the method of visual inertial odometry according to the present disclosure is applied to a mobile device, an embedded device, or a web environment, there is an effect of reducing the trade-off between the computational amount and performance.

Meanwhile, the steps of the method or the algorithm described in connection with an exemplary embodiment of the present disclosure may be implemented directly by hardware, by a software module executed by hardware, or by a combination of hardware and software. The software module may reside in a random access memory (RAM), a read only memory (ROM), an erasable programmable ROM (EPROM), an electrically erasable programmable ROM (EEPROM), a flash memory, a hard disk, a removable disk, a compact disc read-only memory (CD-ROM), or in any form of computer-readable recording media well known in the art to which the invention pertains.

The components of the present disclosure may be embodied as a program (or application) and stored in media for execution in combination with a computer which is hardware. The components of the present disclosure may be executed in software programming or software elements, and similarly, embodiments may be realized in a programming or scripting language such as C, C++, Java, and assembler, including various algorithms implemented in a combination of data structures, processes, routines, or other programming constructions. Functional aspects may be implemented in algorithms executed on one or more processors.

Although preferred embodiments of the method and apparatus for visual inertial odometry according to the present disclosure have been described above, the present disclosure is not limited thereto, and may be implemented with various modifications within the scope of the claims, the detailed description of the invention, and the accompanying drawings, and these also belong to the present disclosure.

What is claimed is:

1. A method of visual inertial odometry performed in an apparatus for visual inertial odometry, the method comprising:
(a) acquiring image data from a camera sensor and acquiring inertial data from an inertial measurement unit;
(b) performing a convolution operation on the image data to extract image feature information and performing the convolution operation on the inertial data to extract inertial feature information;
(c) determining whether to use the image feature information; and
(d) estimating a camera pose based on the used image feature information and the inertial feature information determined to be used according to a result of determining whether to use the image feature information.

2. The method according to claim 1, wherein the (b) includes:
performing a two-dimensional convolution operation on the image data acquired from the camera sensor; and
extracting image feature information corresponding to a texture, an edge, or a color pattern through the two-dimensional convolution operation.

3. The method according to claim 2, further comprising:
prior to the (b), training to estimate an optical flow for extracting the image feature information.

4. The method according to claim 2, wherein the (b) includes:
calculating an amount of change in the image data; and
updating a weight to minimize a calculation error for the camera pose depending on the amount of change.

5. The method according to claim 1, wherein the (b) includes:
performing a one-dimensional convolution operation on the inertial data acquired from the inertial measurement unit; and
extracting the inertial feature information corresponding to the pattern or change over time through the one-dimensional convolution operation.

6. The method according to claim 1, wherein the (c) includes calculating an output value corresponding to a specific element through [Equation 1] below based on the inertial feature information and an output result at a previous time of a long short-term memory.
$${c}_{i} = [ {h}_{t - 1} ; {e}_{t} ] \\ {select}_{t} ( x ) = {\sum }_{i = - a}^{a} {c}_{t} ( x + i ) \cdot K ( i ) \qquad [ Equation 1 ]$$
Here, cₜ denotes an input value, hₜ₋₁ denotes the output result at the previous point of the long short-term memory, et denotes the inertial feature information, and selecₜ(x) denotes an output value corresponding to a specific element x of cₜ.

7. The method according to claim 6, wherein the (c) includes:
applying Gumbel-softmax to the output value to calculate a probability value; and
multiplying the probability value by the output value to change the output value to 0 or 1.

8. The method according to claim 7, wherein the calculating of the probability value includes:
generating Gumbel noise to apply the Gumbel-softmax to the output value;
adding the Gumbel noise to the output value; and
applying a softmax function that adjusts continuity of an output distribution through a temperature parameter to the output value to which the Gumbel noise is added.

9. The method according to claim 8, wherein the calculating of the probability value includes:
generating the Gumbel noise as in [Equation 2] below;
$$G = - log ( - log ( U ) ) \qquad [ Equation 2 ]$$
adding the Gumbel noise to the output value as in [Equation 3] below; and
$${logits}_{gumbel} = logits + G \qquad [ Equation 3 ]$$
applying the softmax function as in [Equation 4] below based on the output value to which the Gumbel noise is added.
$${g}_{i} = \frac{exp ( {( {logits}_{gumbel} )}_{i} / τ )}{{\sum }_{j = 1}^{K} exp ( {( {logits}_{gumbel} )}_{j} / τ )} \qquad [ Equation 4 ]$$
Here, G denotes the Gumbel noise, U denotes a random number sampled from a uniform distribution between 0 and 1, logits denotes the output value, (logits_{gumbel})ᵢ denotes the output value to which the Gumbel noise is added for an i-th class, K denotes the number of classes to be classified, and τ denotes the temperature parameter.

10. The method according to claim 1, wherein the (d) includes:
forming a tensor by connecting the used image feature information and inertial feature information along a dimension axis;
acquiring an output result at a current time of the long short-term memory based on the output result at the previous time of the tensor and the long short-term memory; and
representing the output result at the current time as a vector for each axis through a fully connected layer

11. The method according to claim 1, wherein a loss function is defined as a sum of a loss function for determining whether to use the image feature information and a loss function for estimating the camera pose.

12. The method according to claim 11, wherein the loss function for determining whether to use the image feature information is as in [Equation 5] below where a penalty term is applied as a temperature parameter of Gumbel-softmax.
$${Loss}_{selection} = \frac{1}{seq - 1} {\sum }_{t = 1}^{seq - 1} λ {g}_{i} \qquad [ Equation 5 ]$$
Here, seq denotes a length of a sequence, λ denotes the penalty term, and gₜ denotes a result value of applying the Gumbel-softmax to an output value.

13. The method according to claim 11, wherein the loss function for estimating the camera pose corresponds to a square loss of a Euclidean norm of a translation vector and a rotation vector representing the camera pose as in [Equation 6] below.
$${Loss}_{pose} = \frac{1}{seq - 1} {\sum }_{t = 1}^{seq - 1} ( {‖ \vec{{v}_{t}^{′}} - \vec{{v}_{t}} ‖}_{2}^{2} + α \times {‖ \vec{{r}_{t}^{′}} - \vec{{r}_{t}} ‖}_{2}^{2} ) \qquad [ Equation 6 ]$$
Here, seq denotes a length of a sequence, α=100, \vec{v} denotes the translation vector, and \vec{r} denotes the rotation vector.

14. An apparatus for visual inertial odometry, comprising:
a data acquisition unit that acquires image data from a camera sensor and acquires inertial data from an inertial measurement unit;
an image encoder that performs a convolution operation on the image data to extract image feature information;
an IMU encoder that performs the convolution operation on the inertial data to extract inertial feature information;
a visual determination unit that determines whether to use the image feature information; and
a pose estimation unit that estimates a camera pose based on the used image feature information and the inertial feature information determined to be used according to a result of determining whether to use the image feature information.

15. The apparatus according to claim 14, wherein the visual determination unit calculates an output value corresponding to a specific element based on the inertial feature information and an output value at a previous time of a long short-term memory.

16. The apparatus according to claim 15, wherein the visual determination unit applies Gumbel-softmax to the output value to derive a probability value, and multiplies the probability value by the output value to change the output value to 0 or 1.

17. The apparatus according to claim 16, wherein the visual determination unit generates Gumbel noise to apply the Gumbel-softmax to the output value, adds the Gumbel noise to the output value, and applies a softmax function that adjusts continuity of an output distribution through a temperature parameter to the output value to which the Gumbel noise is added.

18. The apparatus according to claim 1, further comprising:
a learning unit that trains to estimate an optical flow for extracting the image feature information, and updates a weight to minimize a calculation error for the camera pose depending on an amount of change in the image data.

19. A computer program stored in a computer-readable medium, wherein when a command of the computer program is executed, the method according to claim 1 is performed.
